(19) United States
(12) Patent Application Publication
(10) Pub. No.: US 2010/0004355 A1
(43) Pub. Date: Jan. 7, 2010

(54) ANTICORROSIVE COATING COMPOSITION

(75) Inventor: Tomohisa Sumida, Ohtake-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: CHUGOKU MARINE PAINTS, LTD., Ohtake-shi (JP)

(21) Appl. No.: 12/299,045

(22) PCT Filed: Apr. 23, 2007
(86) PCT No.: PCT/JP07/58767

§ 371 Date: Oct. 30, 2008

(30) Foreign Application Priority Data
May 10, 2006 (JP) 2006-131910

(51) Int. Cl. C08L 63/00

(52) U.S. Cl. 523/400

(57) ABSTRACT

The anticorrosive coating composition of the present invention is characterized by comprising (A) an epoxy resin, (B) an amine curing agent and (C) a hydroxyl group-containing coumarone resin wherein the hydroxyl group-containing coumarone resin (C) is contained in an amount of 1 to 500 parts by weight based on 100 parts by weight of the epoxy resin (A). The hydroxyl group-containing coumarone resin (C) preferably has a hydroxyl group content in one molecule of 1 to 5% and a softening point of not higher than 200° C. The anticorrosive coating composition can form a coating film in which the plural resin components are homogeneously mixed and which are excellent in anticorrosion properties, water resistance and adhesion. Further, since the coating composition is free from tar unlike conventional anticorrosive coating compositions, it can form a clear coating film free from bleeding out of any component, and safety and hygiene problems at the time of coating operation thereof do not occur.

### FIELD OF THE INVENTION

The present invention relates to an anticorrosive coating composition. More specifically, the present invention relates to an anticorrosive coating composition, which has excellent seawater resistance, can form gray or light colored coating films and can be used for surface coating on pipe lines under sea water, particularly, is useful for coating on the inside of a ship such as a ballast tank or the like.

### BACKGROUND ART

Conventionally, tar epoxy coatings having excellent anticorrosion properties have been used for application on the inside of a ship such as a ballast tank or the like. The coatings have a problem on safety and hygiene because of containing tar. Since the coatings have a black hue similar to the hue of a steel plate used as a base material, it is difficult to visually inspect the film thickness of a resulting coating film. Therefore, it is difficult to perform the coating operation and inspection thereof when the coating is applied to make a coating film having a uniform thickness. Furthermore, the tar-containing coating film has maintenance and control problems, for example, it is difficult to discern, by visual inspection, whether a steel plate covered with the coating film has corrosion or not, whether a coating film has burn damage caused by thermal influence at the time of welding a steel plate or not, and the condition of a coating film which is changed with time. The tar-containing coating, further, has problems such that the tar is gradually bled out on the top coating layer applied on the tar-containing coating film, to damage the appearance of a coated ship or steel construction or to affect on the properties such as antifouling properties and weathering resistance.

There is conventionally known an anticorrosive coating composition, which comprises an epoxy resin, a coumarone resin and a hydroxyl group-containing terpene phenol resin as main components, and a polyamine or a polyamide as a curing agent. The coating composition, however, has limitations on use that the coumarone resin cannot be used alone because the compatibility between the coumarone resin and the components of the curable epoxy resin and the amine type curing agent is not sufficient and thereby it is essential to add the terpene phenol resin (JP-A-2001-279167: Patent Document 1).

A non-tar coating film free from a non-reactive coating film modifying agent such as coumarone resin or the like has inferior flexibility and a fear of causing a defect at the position where strain is extremely applied.

[Patent Document 1] JP-A-2001-279167

### DISCLOSURE OF THE INVENTION

### Object of the Invention

The present invention is intended to solve the problems as above and it is an object of the invention to provide an anticorrosive coating composition having properties such that the compatibility between resin components contained in the composition is excellent, the plural resin components are homogenously mixed in a resulting cured coating film prepared from the composition, the coating film has no bleeding out of any of the components, coating operation thereof can be carried out without safety and hygiene problems and the application thereof can form a coating film clearer than tar and having excellent anticorrosion properties, water resistance and adhesion.

### Means for Solving the Problem

The present inventors have been earnestly studied to solve the above problems and found that when a certain amount of a coumarone resin containing a hydroxyl group is blended in an anticorrosive coating composition, the compatibility between the components of a curable epoxy resin and an amine curing agent contained in the anticorrosive coating composition is maintained without addition of a terpene phenol resin, and further in a resulting cured coating film prepared from the composition, the coumarone resin and the epoxy resin cured product are uniformly and properly mixed and furthermore, and the use of the anticorrosive coating composition can form a coating film having excellent flexibility and anticorrosion properties. Thus, the present invention has been accomplished.

That is, the anticorrosive coating composition of the present invention comprises (A) an epoxy resin, (B) an amine curing agent and (C) a coumarone resin containing a hydroxyl group wherein the hydroxyl group-containing coumarone resin (C) is contained in an amount of 1 to 500 parts by weight based on 100 parts by weight of the epoxy resin (A).

The hydroxyl group-containing coumarone resin (C) preferably has a hydroxyl group content in one molecule of 1 to 5% and a softening point of not higher than 200° C.

### EFFECT OF THE INVENTION

The resin components contained in the anticorrosive coating composition of the present invention have excellent compatibility and prepare a cured coating film in which the epoxy resin cured product and the specific coumarone resin are uniformly mixed. Therefore, the use of the anticorrosive coating composition of the present invention can form a coating film having excellent flexibility, anticorrosion properties and water resistance without using tar or a terpene phenol resin and the resulting coating film has no bleeding out (exudation) of the specific coumarone resin or the other components. Additionally, the anticorrosive coating composition of the invention can be prepared as a high solid type coating material having a high solid content and thereby can make a film to be thick.

Since the coating composition of the present invention is free from tar, it can form a clear coating film having properties such that the visual inspection thereof can be easily carried out and the appearance and coating film properties are not marred by bleeding out, and further, safety and hygiene problems at the time of coating operation thereof do not occur.

### BEST MODE FOR CARRYING OUT THE INVENTION

Anticorrosive Coating Composition

The anticorrosive coating composition of the present invention comprises (A) the epoxy resin, (B) the amine type curing agent and (C) the coumarone resin containing a hydroxyl group. These components and the blending proportion will be described progressively below.

<Epoxy Resin (A)>

The epoxy resin (A) contained in the anticorrosive coating composition of the present invention is a resin containing at least two epoxy groups in one molecule. Examples of the epoxy resin may include epoxy resins as described in JP-A-2001-279167 columns [0014] to [0016] filed by the present applicant (Patent Document 1) such as bisphenol A type, bisphenol F type, bisphenol AD type, bisphenol K type and bisphenol S type epoxy resins, and further dimer acid modified and polysulfide modified epoxy resins, and hydrogenated epoxy resins having an aromatic ring structure. In the present invention, it is preferred to use aromatic epoxy resins such as bisphenol A type and bisphenol F type epoxy resins as the epoxy resin (A) in the point of capable of forming a coating film having excellent adhesion strength.

The epoxy resin (A) of the invention has an epoxy equivalent of usually from 150 to 600, preferably 150 to 500 and is preferably a bisphenol type epoxy resin in a liquid or solid state at ordinary temperature in the point of preparing a coating having a high solid content.

Examples of the bisphenol A type epoxy resin are bisphenol A type diglycidyl ethers such as bisphenol A diglycidyl ether, bisphenol A polypropylene oxide diglycidyl ether, bisphenol A ethylene oxide diglycidyl ether, hydrogenated bisphenol A diglycidyl ether and hydrogenated bisphenol A propylene oxide diglycidyl ether.

Typical examples of the bisphenol type epoxy resins in a liquid state at ordinary temperature may include “Epikote 828” (epoxy equivalent: 180 to 190, manufactured by Shell Co.), “Epotohto YDF-170” (epoxy equivalent: 160 to 180, manufactured by Tohto Kasei Co., Ltd.), “Flep 60” (epoxy equivalent: about 280, manufactured by Toray Thiokol Co., Ltd.) and “E-028-90X” (epoxy equivalent: 210, manufactured by Otake Meishin Chemical Co. Ltd).

Typical examples of the bisphenol type epoxy resins in a semi-solid state at ordinary temperature may include “Epikote 834” (epoxy equivalent: 230 to 270, manufactured by Shell Co.), “Epotohto YD-134” (epoxy equivalent: 230 to 270, manufactured by Tohto Kasei Co., Ltd.) and “E-834-85X(T)” (epoxy equivalent: 300, manufactured by Otake Meishin Chemical Co. Ltd).

Typical examples of the bisphenol type epoxy resins in a solid state at ordinary temperature may include “Epikote 1001” (epoxy equivalent: 450 to 500, manufactured by Shell Co.) and “E-001-75X” (epoxy equivalent: 600, manufactured by Otake Meishin Chemical Co. Ltd).

These epoxy resins may be used singly or combined with two or more for use.

<Amine Type Curing Agent (B)>

Conventionally and widely known curing agents for epoxy resins can be used as the amine curing agent (B) in the invention. According to the kind of the epoxy resin (A), an amine type curing agent capable of curing the epoxy resin by reaction therewith may be selected properly.

Examples of the amine type curing agents (B) in the invention may include polyamine type curing agents, modified polyamine type curing agents, polyamide type curing agents such as polyamide amine, and modified polyamide type curing agents, as disclosed in JP-A-2001-279167 columns [0017] to [0021] filed by the present applicant (Patent document 1).

Examples of the modified polyamine type curing agents are modified products of polyamines, for example, aliphatic polyamines, alicyclic polyamines and aromatic polyamines such as methaxylene diamine, isophorone diamine, diethylene triamine, triethylene tetramine or diaminodiphenyl methane. Specific examples are aliphatic, alicyclic or aromatic polyamines obtainable by modifying a polyamine with epoxide addition, Michael addition, Mannich addition, thiourea addition, acrylonitrile addition or ketone terminating.

Examples of the polyamide type curing agents are polyamides obtainable by allowing a dimer acid to react with an amine such as aliphatic polyamines, alicyclic polyamines or aromatic polyamines, as described above. Specific examples are “Luckamide N-153” (amine value: 80 to 120, manufactured by Dainippon Ink and Chemicals Inc.), “Luckamide TD-966” (amine value: 150 to 190, manufactured by Dainippon Ink and Chemicals Inc.), “Sunmide 315” (amine value: 280 to 340, manufactured by Sanwa Chemical Industry Co., Ltd.), “PA66” (amine value: 80 to 140, manufactured by Ohtake Meishin Chemical Co., Ltd.), “PA290” (amine value: 140 to 200, manufactured by Ohtake Meishin Chemical Co., Ltd.) and “MAD204” (amine value: 220 to 280, manufactured by Ohtake Meishin Chemical Co., Ltd.).

Examples of the modified polyamide type curing agents, which are modified products of the above polyamides, may include epoxy adducts obtainable by adding an epoxy compound on a polyamide, such as “PA-23” (amine value: 80 to 150, manufactured by Ohtake Meishin Chemical Co., Ltd.), and Mannich modified products of a modified polyamide such as “Adeka hardener EH-350) (amine value: 320 to 380, manufactured by Adeka Co., Ltd.).

The curing agents such as polyamines, modified polyamines, polyamides and modified polyamides used in the invention have an amine value of usually 50 to 1000, preferably 80 to 500. When the curing agent (B) has an amine value in the above range, the resulting coating film tends to have an improved balance between drying properties and adhesion strength. These curing agents are usually in a liquid or solid state.

<Hydroxyl Group-Containing Coumarone Resin (C)>

In the present invention, the hydroxyl group-containing coumarone resin is blended in the anticorrosive coating composition. The hydroxyl group-containing coumarone resin (C) preferably contains 1 to 5% of a hydroxyl group in one molecule, as measured by an acetylation method, from the viewpoint of anticorrosion properties of the resulting coating film.

The hydroxyl group-containing coumarone resin (C) has a softening point of preferably not higher than 200° C., more preferably not higher than 150°, specifically not higher than 100°, and it may be in a liquid state at ordinary temperature. The softening point of the hydroxyl group-containing coumarone resin (C) is undesirably over the above range in the present invention, because the compatibility with the epoxy resin or the cured product thereof becomes low or inferior.

The hydroxyl group-containing coumarone resin (C) has a number average molecular weight (Mn), as determined with GPC measurement, of usually 80 to 700, preferably 100 to 500.

The hydroxyl group-containing coumarone resin (C) satisfying the above conditions can be prepared by, for example, adding phenol in the preparation of the coumarone resin followed by copolymerization in accordance with ordinary methods. Furthermore, it is commercially available and examples are “NOVARES CA 100” (a softening point of 100° C. and a hydroxyl group content, as determined by ROTGERS-Method, of 2.2 to 2.7%) and “NOVARES CA 80” (a softening point of 80° C. and a hydroxyl group content, as determined by ROTGERS-Method, of 3.3 to 3.8%), which are manufactured by Rutgers Chemicals AG. These hydroxyl group-containing coumarone resins may be used singly or combined with two or more for use.

<Other Components>

Together with the anticorrosive coating composition of the invention, coumarone resins free from a hydroxyl group, xylene resins and terpene phenol resins may be used within the limit of not affecting the compatibility with the curing resins in addition to the hydroxyl group-containing coumarone resin (C).

Furthermore, to the anticorrosive coating composition of the invention, it is possible to optionally add pigments such as extender pigments, anticorrosive pigments or coloring pigments; and usual additives for coatings such as reactive diluents, organic solvents, anti-settling agents, anti-sagging agents, lubricants, reaction accelerators, tackifiers and dehydrating agents.

Preparation Process of Coating Composition and Coating Method

The anticorrosive coating composition of the present invention can be prepared by mixing (A) the epoxy resin, (B) the amine-type curing agent, (C) the hydroxyl group-containing coumarone resin, the solvents and the other components with an ordinary process. In general, the coating composition is a two-liquid type coating, which comprises a main component including (A) the epoxy resin and (C) the hydroxyl group-containing coumarone resin, and a curing agent including (B) the amine-type curing agent. The main component and the curing agent are prepared separately, and then they are mixed at the time of use thereof and submitted to use.

The anticorrosive coating composition of the invention comprises the hydroxyl group-containing coumarone resin (C) in an amount of 1 to 500 parts by weight, preferably 20 to 200 parts by weight based on 100 parts by weight of the epoxy resin (A). The content of the hydroxyl group-containing coumarone resin (C) is preferably in the above range because the composition has excellent coating film strength, anticorrosion properties and other properties. When the content is lower than the above range, a resulting coating film tends to have low flexibility. When the content is more than the above range, a resulting coating film is brittle and unable to have good physical properties such as anticorrosion properties.

To the anticorrosive coating composition of the invention, it is effective to add the curing agent (B) in an amount such that the ratio of the number of active hydrogen equivalent in the curing agent (B) (weight of the curing agent (B)/active hydrogen equivalent weight) to the number of epoxy equivalent in the epoxy resin (A) (weight of epoxy resin (A)/epoxy equivalent weight) is preferably 0.4 to 1.0, more preferably 0.5 to 0.9 in consideration of coating film physical properties or coating operation properties.

The anticorrosive coating composition of the invention is a high solid coating (for example, solid content of 70 to 95 wt %) which solid content is higher as compared with conventional coatings.

The anticorrosive coating composition of the invention thus prepared can be applied on the surface of a ship or steel construction with ordinary methods, for example, an airless spray, air spray, brush coating or roller coating. After the application, the composition is dried and cured to form an anticorrosive coating film having the above excellent properties. At the time of coating, the anticorrosive coating composition may be appropriately diluted with a thinner and the like.

### Examples

Hereinafter, the anticorrosive coating composition of the present invention is described in more detail with reference to the following examples, however, the examples should not be construed as limiting the scope of the invention.

### Examples 1 to 2 and Comparative Examples 1 to 5

Anticorrosive coating compositions having the blend composition as shown in Table 1 was prepared by mixing with a stirrer in accordance with ordinary methods.

The resulting anticorrosive coating compositions were submitted to test on the testing items as shown in Table 1 by the following testing methods. The results are shown together in Table 1.

<Performance Test>

### (1) Flex Resistance Test

A plate for testing having a size of 150 mm×50 mm×0.3 mm was coated using each of the anticorrosive coatings in an amount such that a resulting dried film has a thickness of about 250 μm using an air spray, and dried under an atmosphere of 23° C. and 50% RH for 7 days to prepare a test plate. Using the test plate, the flex resistance of a resulting coated film was evaluated based on the following criteria (in accordance with JIS K-5600, 5-1).

(Evaluation Criteria)

AA: Cracks and peeling were not observed.

BB: Fine cracks were observed, but peeling was not observed.

CC: Peeling was observed.

### (2) Impact Resistance Test

A plate for testing having a size of 150 mm×70 mm×1.6 mm was coated using each of the anticorrosive coatings in an amount such that a resulting dried film has a thickness of about 250 μm using an air spray, and dried under an atmosphere of 23° C. and 50% RH for 7 days to prepare a test plate. Using the test plate, the impact resistance was evaluated in accordance with the ISO-6272 DuPont method by an impact testing machine (product name: Dupont type impact testing machine manufactured by Taiyu Co., Ltd) under conditions of ¼ inch and 1 Kg×50 cm. The impact resistance of a resulting coated film was evaluated based on the following criteria.

(Evaluation Criteria)

AA: Peeling having a diameter of less than 13 mm.

BB: Peeling having a diameter of not less than 13 mm and less than 18 mm.

CC: Peeling having not less than 18 mm.

### (3) Salt Water Resistant Test

A test plate prepared in the same method as in the impact resistance test (2) was immersed in 3% salt water at 40° C. for 90 days. Thereafter, the appearance of a coated film was evaluated based on the following criteria (in accordance with JIS K-5600 6-1).

(Evaluation Criteria)

AA: Change on any of swell, crack, rust, peeling and hue was not observed.

BB: Defect (change) on any of swell, crack, rust, peeling and hue was somewhat observed.

CC: Change on any of swell, crack, rust, peeling and hue was clearly observed.

### (4) Electric Anticorrosion Test

A test plate prepared in the same method as in the impact resistance test (2) was immersed in 3% salt water at 40° C. for 90 days. Thereafter, in accordance with ASTM G-8, the appearance of a coated film was evaluated based on the following criteria.

(Evaluation Criteria)

AA: Change on any of swell, crack, rust, peeling and hue was not observed.

BB: Defect (change) on any of swell, crack, rust, peeling and hue was somewhat observed.

CC: Change on any of swell, crack, rust, peeling and hue was clearly observed.

### (5) High Temperature and High Humidity Resistance Test

A test plate prepared in the same method as in the impact resistance test (2) was kept in a testing vessel at a temperature of 50° C. and a humidity of 95% for 90 days. Thereafter, the appearance of a coated film was evaluated based on the following criteria (in accordance with JIS K-5600 6-1).

(Evaluation Criteria)

AA: Change on any of swell, crack, rust, peeling and hue was not observed.

BB: Defect (change) on any of swell, crack, rust, peeling and hue was somewhat observed.

CC: Change on any of swell, crack, rust, peeling and hue was clearly observed.

### (6) Test for Difference in Temperature

A test plate prepared in the same method as in the impact resistance test (2) was immersed in an immersing vessel in which the coated film surface was contacted to 50° C. hot water and the back was contacted to 20° C. water for 14 days. After the immersion, the conditions of the coated film (the size and occurrence grade of swell) were evaluated based on the following criteria using ASTM grade mark (ASTM D714-56).

(Evaluation Criteria)

Size of Swell:
No. 10: None
No. 8: Smallest size
No. 6: Medium size
No. 4: Large size

Occurrence grade of Swell:
D: Dense
MD: Medium dense
M: Medium
F: Few

Successively, the coated film of each of the test plates was cut to make a cross cut form by a knife and the adhesion of the coated film was evaluated based on the following criteria (in accordance with JIS K-5600 6-18.5.3).

(Evaluation Criteria)

AA: Peeling was not observed on the coated film (good in adhesion).

BB: Peeling was partly observed.

CC: The coated film was peeled. (defective in adhesion)

The description on the blending components (goods) used in the examples and comparative examples is as follows.

(Notation for Table 1)

(*1) “E-001-75X” manufactured by Ohtake Meishin Chemical Co., Ltd.: Bisphenol A type solid epoxy resin having an epoxy equivalent of 600 and a solid content of 75%.

(*2) “E-834-85X(T)” manufactured by Ohtake Meishin Chemical Co., Ltd.: Bisphenol A type semi-solid epoxy resin having an epoxy equivalent of 300 and a solid content of 85%.

(*3) “E-028-90X” manufactured by Ohtake Meishin Chemical Co., Ltd.: Bisphenol A type liquid epoxy resin having an epoxy equivalent of 210 and a solid content of 90%.

(*4) “NOVARES CA 100” manufactured by Rutgers Chemicals AG: a hydroxyl group-containing coumarone resin having a softening point of 100° C., a hydroxyl group content of 2.2 to 2.7% and a solid content of 100%.

(*5) “ESUCRON V-120” manufactured by Nippon Steel Chemical Co., Ltd: a coumarone resin having a softening point of 120° C., no OH value and a solid content of 100%.

(*6) “NIKANOL K-100” manufactured by Fudow Co., Ltd.: a hydroxyl group-containing xylene resin in a liquid state having an OH value of 90 (mgKOH/g), a viscosity of 340 mPa·s/75° C. and an average molecular weight of 500.

(*7) “RT 4133-DK” manufactured by Rutgers Kureha Solvents GmbH: a hydroxyl group-containing diisopropyl naphthalene resin in a liquid state having a hydroxyl group content of 2.4 to 2.6%.

(*8) “ASA T-250F” manufactured by Itoh Oil Chemicals Co., Ltd.: an anti-sagging agent, amide wax having a solid content of 100%.

(*9) “KBM403” manufactured by ShinEtsu Chemical Co., Ltd.: a silane coupling agent in a liquid state having an epoxy equivalent of 236.

(*10) “PA66” manufactured by Ohtake Meishin Chemical Co., Ltd.: polyamide amine having a solid content of 60% and an amine value of 110.

(*11) “MAD204” manufactured by Ohtake Meishin Chemical Co., Ltd.: modified polyamine having a solid content of 65% and an amine value of 250.

(*12) “PA290” manufactured by Ohtake Meishin Chemical Co., Ltd.: polyamide amine having a solid content of 60% and an amine value of 166.

(*13) “Ancamine K-54” manufactured by Air Products Co., Ltd.: ternary amine in a liquid state.

(*14) “Biscon HB-200” manufactured by Chugoku Marine Paints Ltd.: a main component for a tar epoxy resin coating material used in Comparative Example 4 which comprises mainly an epoxy resin “E-001-75X” (a solid content of 75%), “E-834-85X(T)” (a solid content of 85%), a tar (a solid content of 77%), talc and xylene.

(*15) “Biscon HB-200 curing agent” manufactured by Chugoku Marine Paints Ltd.: a polyamide amine type curing agent for a tar epoxy resin coating material used in Comparative Example 4 having a solid content of 42%.

(*16) “BANNOH 500” manufactured by Chugoku Marine Paints Ltd.: a main component for a tar free epoxy resin coating material used in Comparative Example 5 which comprises mainly an epoxy resin “E-001-75X” having a solid content of 75%, “E-834-85X(T)” having a solid content of 85%, talc, barium sulfate, mica and xylene.

(*17) “BANNOH 500 curing agent” manufactured by Chugoku Marine Paints Ltd.: a polyamide amine curing agent for a tar free epoxy resin coating material used in Comparative Example 5, having a solid content of 57%.

TABLE 1

| Example | | Comparative Example | | | | |
|---|---|---|---|---|---|---|
| 1 | 2 | 1 | 2 | 3 | 4 | 5 |

Components of Coating composition (parts by weight)

| | | | | | | | |
|---|---|---|---|---|---|---|---|
| Epoxy resin (*1) | 7 | — | — | — | — | Main | Main |
| Epoxy resin (*2) | 9 | — | — | — | — | compo- | compo- |
| Epoxy resin (*3) | — | 16 | 16 | 18 | 18 | nent | nent |
| Hydroxyl group- cont. | 9 | 13 | — | — | — | for tar | for epoxy |
| coumarone resin (*4) | | | | | | epoxy | resin |
| Coumarone resin (*5) | — | — | 13 | — | — | resin | coating |
| Xylene resin (*6) | — | — | — | 11 | — | coating | (*16) |
| Reutasolv RT (*7) | — | — | — | — | 11 | (*14) | |
| Titanium white | 3.6 | 4 | 4 | 4 | 4 | | |
| Carbon black | 0.05 | 0.05 | 0.05 | 0.05 | 0.05 | | |
| Talc | 35 | 40 | 40 | 40 | 40 | | |
| Mica | — | 3 | 3 | 3 | 3 | | |
| Anti-sagging agent (*8) | 2 | 1.5 | 1.5 | 1.5 | 1.5 | | |
| Xylene | 21.85 | 9.95 | 9.95 | 9.95 | 9.95 | | |
| Silane coupling agent (*9) | 0.5 | 0.5 | 0.5 | 0.5 | 0.5 | | |
| Subtotal | 88 | 88 | 88 | 88 | 88 | 90 | 87 |
| Polyamide amine (*10) | 11 | — | — | — | — | Curing | Curing |
| Modified polyamine (*11) | — | 7 | 7 | 7 | 7 | agent | agent |
| Polyamide amine (*12) | — | 3.5 | 3.5 | 3.5 | 3.5 | (*15) | (*17) |
| Ternary amine (*13) | 0.3 | 0.3 | 0.3 | 0.3 | 0.3 | | |
| Xylene | 0.7 | 1.2 | 1.2 | 1.2 | 1.2 | | |
| Subtotal | 12 | 12 | 12 | 12 | 12 | 10 | 13 |
| Total | 100 | 100 | 100 | 100 | 100 | 100 | 100 |

Properties of Coating film

| | | | | | | | |
|---|---|---|---|---|---|---|---|
| Color | gray | gray | gray | gray | gray | black | gray |
| Flex resistance | AA | AA | AA | AA | AA | AA | BB |
| Impact resistance | AA | AA | AA | AA | AA | AA | AA |
| Salt water resistance | AA | AA | BB | CC | BB | AA | AA |
| Electric anticorrosion | AA | AA | BB | CC | BB | AA | AA |
| High temper. and | AA | AA | AA | AA | AA | AA | AA |
| humidity resistance | | | | | | | |
| Water resistance in | 10/BB | 10/BB | 8M/BB | 8F/BB | 8M/BB | 10/BB | 10/BB |
| temperature difference | | | | | | | |

1. An anticorrosive coating composition comprising:
(A) an epoxy resin,
(B) an amine curing agent and
(C) a hydroxyl group-containing coumarone resin wherein the hydroxyl group-containing coumarone resin (C) is contained in an amount of 1 to 500 parts by weight based on 100 parts by weight of the epoxy resin (A).

2. The anticorrosive coating composition according to claim 1 wherein the hydroxyl group-containing coumarone resin (C) contains a hydroxyl group in an amount of 1 to 5% in one molecule and has a softening point of not higher than 200° C.
